(19) United States
(12) Patent Application Publication
(10) Pub. No.: US 2017/0295994 A1
(43) Pub. Date: Oct. 19, 2017

(54) Charcoal Starter

(71) Applicants: Vadim Gordin, Louisville, KY (US); Christopher Hawker, Columbus, OH (US); Joel Beebe, Columbus, OH (US)

(72) Inventors: Vadim Gordin, Louisville, KY (US); Christopher Hawker, Columbus, OH (US); Joel Beebe, Columbus, OH (US)

(21) Appl. No.: 15/132,360

(22) Filed: Apr. 19, 2016

(51) Int. Cl. A47J 37/07; F24B 15/00; F23Q 13/00

(52) U.S. Cl. CPC A47J 37/079; F23Q 13/00; F24B 15/005

(57) ABSTRACT

A charcoal starter for use with charcoal briquettes or hardwood is disclosed. The invention provides improvements directed to both the manufacture and use of charcoal chimneys, specifically the safety and ease of dispersal of lit coal.

### BACKGROUND/FIELD

Within the grilling arts the traditional method of igniting charcoal is in a pile and dowsed in lighter fluid. That being said, it is often advantageous to ignite charcoal using faster methods and those which do not require unpleasant tasting liquid fuels.

Consequently, improved devices are disclosed herein for igniting charcoal.

### SUMMARY

According to certain embodiments of the present disclosure, a charcoal starter includes; an elongated tubular body having a handle disposed on a first side thereof and a door pivotably coupled to a second side disposed substantially opposite the first side; and within the tubular body, there is an angled grate sized and shaped to allow the passage of air but not charcoal therethrough, with the grate disposed at an angle greater than 5 degrees and less than 45 degrees to the short axis of the body.

According to further embodiments of the present disclosure, the door is pivotably hinged to the body about a ventral edge of the door.

According to further embodiments of the present disclosure, the movement of the door about is modulated by a coupling which terminates near the handle.

According to further embodiments of the present disclosure, the coupling extends around the outside of the body.

According to further embodiments of the present disclosure, there is a removable secondary grate which may be placed upon a dorsal opening of the charcoal starter to provide a grilling surface.

According to further embodiments of the present disclosure, there is a locking mechanism which limits the travel of the coupling, with the locking mechanism defining two coupling mechanism configurations, a first configuration in which the door is urged towards the tubular body and a second configuration in which a gap is created between the door and the tubular body so as to allow granular media disposed within the body to pass therethrough.

According to further embodiments of the present disclosure, the door is pivotably hinged to the body about a dorsal edge thereof.

According to further embodiments of the present disclosure, a charcoal starter includes an elongated tubular body having a handle disposed on a first side thereof and a door pivotably coupled to a second side disposed substantially opposite the first side; and within the tubular body, there is an angled grate sized and shaped to allow the passage of air but not charcoal therethrough, with the grate disposed at an angle greater than 5 degrees and less than 45 degrees to the short axis of the body wherein the movement of the door about is modulated by a coupling which terminates near the handle.

According to further embodiments of the present disclosure, a charcoal starter includes an elongated tubular body having a handle disposed on a first side thereof and a door pivotably coupled to a second side disposed substantially opposite the first side; and within the tubular body, there is an angled grate sized and shaped to allow the passage of air but not charcoal therethrough, with the grate disposed at an angle greater than 5 degrees and less than 45 degrees to the short axis of the body, wherein the door is pivotably hinged to the body about a ventral edge of the door.

### BRIEF DESCRIPTION OF THE FIGURES

In the figures, which are not necessarily drawn to scale, like numerals describe substantially similar components throughout the several views. The drawings illustrate generally, by way of example, but not by way of limitation, various embodiments discussed in the claims of the present document.

FIG. 1 shows a top isometric through-wireframe view of a charcoal starter in an open condition.

FIG. 2 shows a top isometric view of a charcoal starter in a closed or “locked” condition.

FIG. 3 shows a top view of a charcoal starter.

FIG. 4 shows a rear bottom isometric view of a charcoal starter.

### DETAILED DESCRIPTION OF THE FIGURES

Various embodiments of the presently disclosed apparatus will now be described in detail with reference to the drawings, wherein like reference numerals identify similar or identical elements. In the drawings and in the description that follows, the term “proximal,” will refer to the end of a device or system that is closest to the operator, while the term “distal” will refer to the end of the device or system that is farthest from the operator. Similar, anatomical terms of reference such as dorsal, lateral, anterior, and sagittal shall have their accepted meanings in the arts.

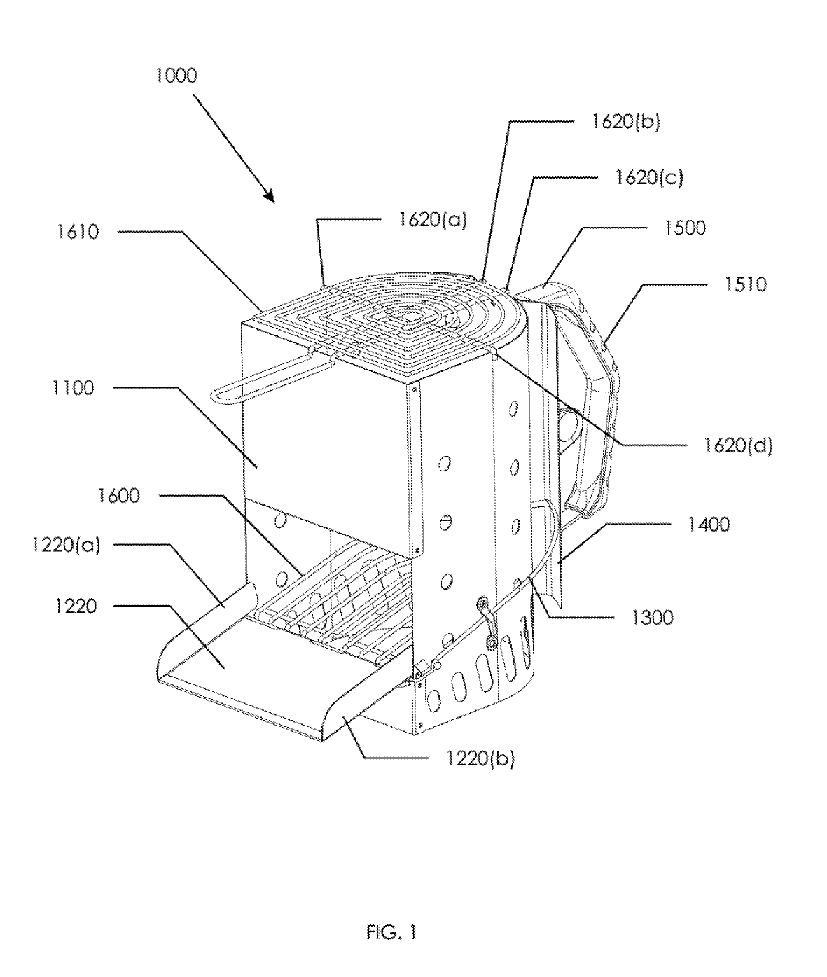

According to a first embodiment of the present disclosure shown in FIG. 1, a charcoal chimney 1000 comprises an elongated body 1100 having a door 1200 pivotably coupled to a distal face thereof, with the door 1200 pivotably coupled to an actuation arm 1300. Chimney 1000 further comprises a heat shield 1400 affixed to a proximal face of body 1100 with a handle 1500 extending therefrom. There is a grilling grate 1600 removably coupled to the cephalic end portion of body 1100.

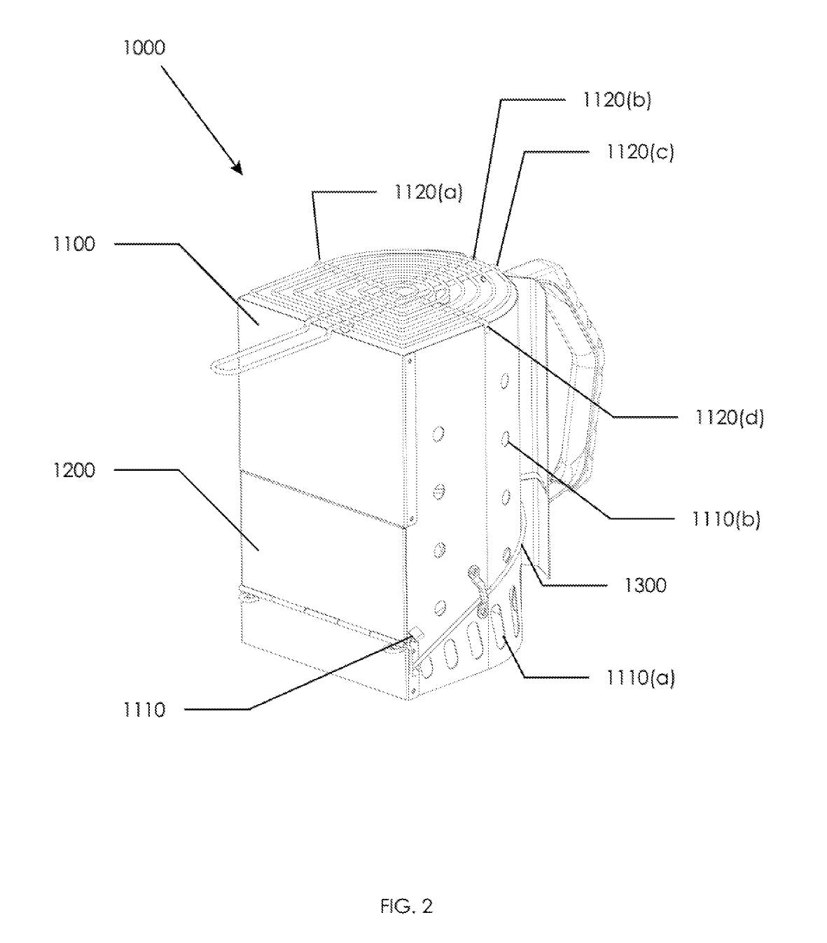

Referring now to FIGS. 1 and 2 together, body 1100 is shown having a substantially d-shaped cross-section with an arc at the proximal end thereof and a flat at the distal end thereof. Handle 1500 and heat shield 1400 are affixed to body 1100 at contact points 1105 and 1106. Contact points 1105 and 1106 are sized and shaped so as to minimize the contact surface and consequently heat transfer therebetween. There is a grip 1510 affixed to handle 1500 where the grip 1510 is composed of a material which does not transmit heat including for instance wood or silicone.

Referring now to FIG. 2 a charcoal starter 1000 is shown in a second, open condition, with door 1200 disposed at an angle theta to the distal face of body 1100. Actuation arm 1300 is pivotably coupled to the caudal end portion of door 1200 such that translating actuation arm 1300 proximally relative to body 1100 pivots the door 1200 relative to body 1100. There is a stop-point 1110 disposed upon body 1100 which impedes the motion of actuation arm 1300 beyond a certain point, thereby defining the outer limit of the travel of door 1200. Door 1200 has bent sides 1220(a and b) disposed on opposing lateral sides thereof sized and shaped to engage removably upon the sides of body 1100 when the door is pressed thereagainst and to act as guides for media leaving the body when the device is configured in an open configuration as shown in FIG. 2.

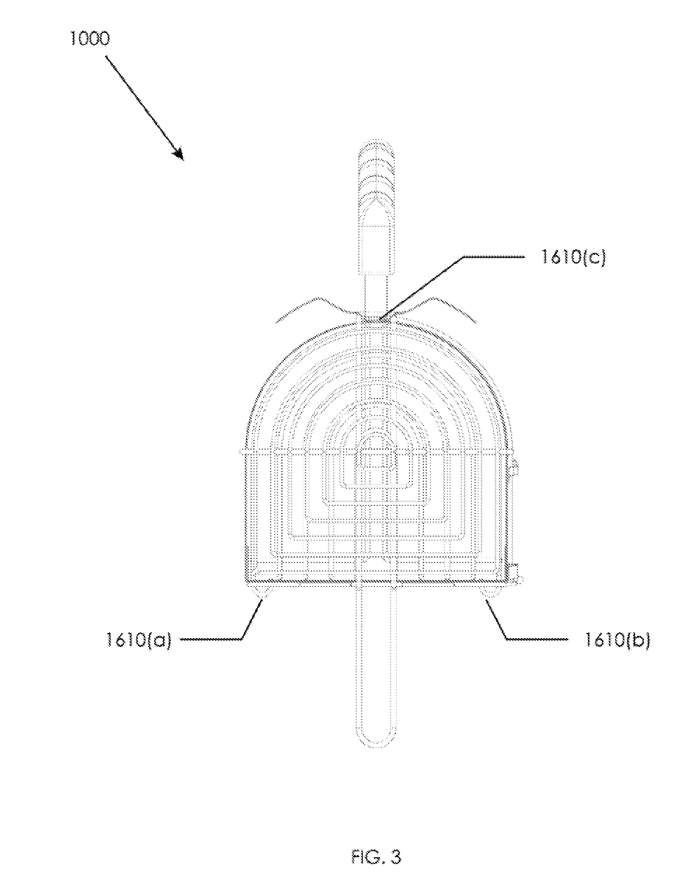

With continued reference to FIG. 3, there are a plurality of aperture vents 1110(a-d) dispos;ed upon body 1100 sized and shaped to allow the passage of air into the interior of body 1100. Further, there are a plurality of apertures 1120(a-d) disposed at an angle zeta to the long axis of body 1100 through which the outer protrusions 1610 of an internal grate 1600 are affixed to body 1100. Internal grate 1600 is inclined such that course fuel, including for instance lump or briquette charcoal disposed within body 1100 and resting upon internal grate 1600 will exit the body upon the translation of door 1200 into an open configuration.

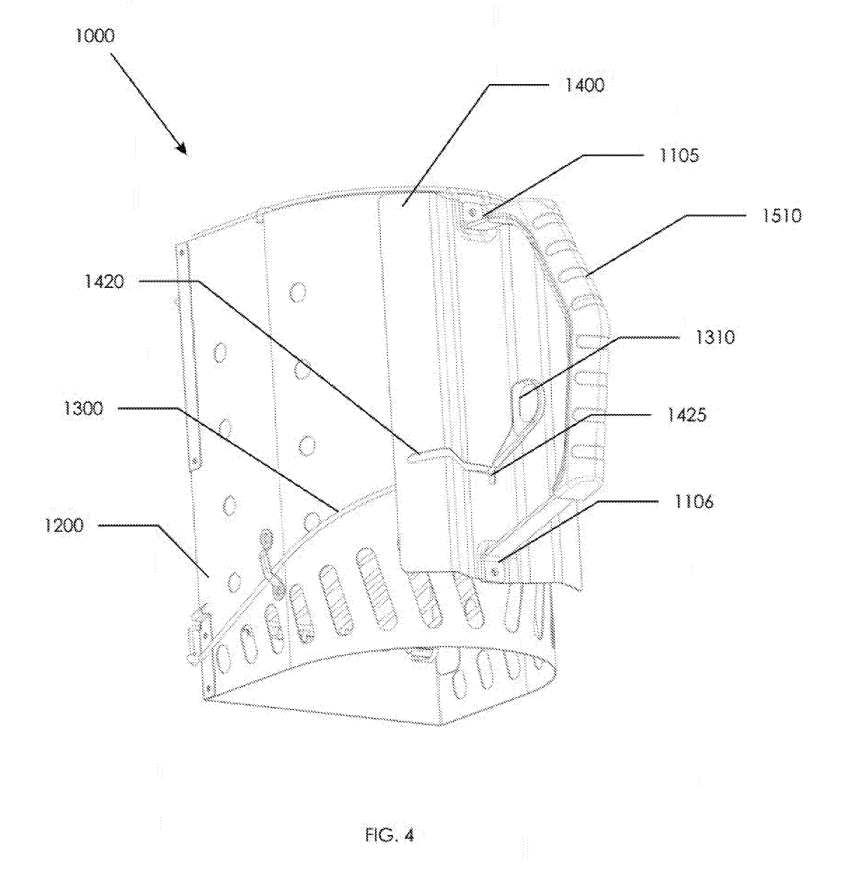

Referring now to FIG. 4, there is a pull tab 1310 disposed upon the proximal-end portion of actuation arm 1300 sized and shaped to be grasped and translated proximally by the digits of a user who is grasping handle 1500. There is a long aperture 1420 disposed upon heat shield 1400 and having a further recess 1425 thereupon sized and extending caudally from aperture 1420, wherein recess 1425 and aperture 1420 are sized and shaped to provide a channel within which actuation arm 1300 can travel along its path. When actuation arm 1300 is engaged within recess 1425, the assembly is in a “locked” configuration where the door 1200 will resist opening until pull-tab 1310 is translated cephalically relative to heat shield 1400.

With returning reference to FIG. 1, grilling grate 1600 is a removable cooking surface having a cooking surface 1610 comprised of a length of wire bent into a substantially planar configuration. Grilling grate 1600 further includes gripping area 1620 which is a portion of metal wire shaped to approximate a handle which extends away from grate 1600. There are a plurality of wire protrusions 1620(a, b, c, and d) extending outwardly from grilling grate 1600 sized and shaped to engage grilling grate 1600 upon body 1100.

A method of using chimney starter 1100 will now be described. Chimney starter 1100 is provided in a first condition, as shown in FIG. 2, with the actuation arm in a “locked” configuration. The portion of the body 1100 above internal grate 1600 is filled with a desired amount of fuel, including for instance charcoal and the portion below internal grate 1600 is filled with a desired amount of kindling, including for instance newspaper. Next, the kindling is ignited using a match or lighter. As the kindling burns, it heats the kindling and coal thereabove, thereby starting a reaction that proceeds as is well known in the grilling arts. When the fuel has reached the desired state, the user grasps the handle with body hands and positions the distal face of the device above the area where he desires charcoal to be deposited. Next, the grip tab is translated first cephalically and then laterally such that the door 1200 opens and the charcoal is deposited in the desired location.

It will be apparent to one having ordinary skill in the mechanical arts that one way of creating the hereindescribed device is with cut, bent and riveted sheet metal for the body, door, and handle, bent and welded wire for the two grates, and silicone for the grip portion of the handle. One having ordinary skill in the arts will further appreciate that such materials as well as the specific structures described herein is but one manner in which the appended claims can be executed and is intended to serve as an enabling example rather than a limiting description.

What is claimed is:

1. A charcoal starter comprising;
An elongated tubular body having a handle disposed on a first side thereof and a door pivotably coupled to a second side disposed substantially opposite the first side; and within the tubular body, there is an angled grate sized and shaped to allow the passage of air but not charcoal therethrough, with the grate disposed at an angle greater than 5 degrees and less than 45 degrees to the short axis of the body.

2. The charcoal starter of claim 1, wherein the door is pivotably hinged to the body about a ventral edge of the door.

3. The charcoal starter of claim 2, wherein the movement of the door about is modulated by a coupling which terminates near the handle.

4. The charcoal starter of claim 3, wherein the coupling extends around the outside of the body.

5. The charcoal chimney of claim 1, wherein there is a removable secondary grate which may be placed upon a dorsal opening of the charcoal starter to provide a grilling surface.

6. The charcoal starter of claim 3, wherein there is a locking mechanism which limits the travel of the coupling, with the locking mechanism defining two coupling mechanism configurations, a first configuration in which the door is urged towards the tubular body and a second configuration in which a gap is created between the door and the tubular body so as to allow granular media disposed within the body to pass therethrough.

7. The charcoal starter of claim 1, wherein the door is pivotably hinged to the body about a dorsal edge thereof.

8. A charcoal starter comprising;
An elongated tubular body having a handle disposed on a first side thereof and a door pivotably coupled to a second side disposed substantially opposite the first side; and within the tubular body, there is an angled grate sized and shaped to allow the passage of air but not charcoal therethrough, with the grate disposed at an angle greater than 5 degrees and less than 45 degrees to the short axis of the body wherein the movement of the door about is modulated by a coupling which terminates near the handle.

9. A charcoal starter comprising;
An elongated tubular body having a handle disposed on a first side thereof and a door pivotably coupled to a second side disposed substantially opposite the first side; and within the tubular body, there is an angled grate sized and shaped to allow the passage of air but not charcoal therethrough, with the grate disposed at an angle greater than 5 degrees and less than 45 degrees to the short axis of the body, wherein the door is pivotably hinged to the body about a ventral edge of the door.
